(19) United States
(12) Patent Application Publication
(10) Pub. No.: US 2015/0037755 A1
(43) Pub. Date: Feb. 5, 2015

(54) Dental Extraction Burs for Extraction of a tooth or a portion of a Tooth

(71) Applicants: Larry Eugene Orr, Logan, UT (US); Patricia Raymond Luzzader, (US)

(72) Inventors: Wayne Richard Luzzader, Hyde Park, UT (US); Larry Eugene Orr, Logan, UT (US)

(21) Appl. No.: 14/243,490

(22) Filed: Apr. 2, 2014

Related U.S. Application Data
(60) Provisional application No. 61/853,280, filed on Apr. 2, 2013.

(51) Int. Cl. A61C 3/02

(52) U.S. Cl. CPC A61C 3/02
USPC 433/165

(57) ABSTRACT

Various Dental Extraction Burs are provided to practitioners to assist them in the extraction of a tooth or a portion of a tooth. Some Extraction Burs are embedded in a hole drilled in the tooth or portion of tooth, while others are attached to the surface of the tooth. After the Extraction Bur is attached to the tooth, the practitioner secures a handle to the Extraction Bur. Using the handle, the Extraction Bur and tooth or portion of tooth is removed from the patient.

### THE FIELD OF THE INVENTION

The present invention generally relates to the field of dentistry and more particularly to the extraction of a tooth or a portion of a tooth from humans or animals.

### THE BACKGROUND ART OF THE INVENTION

Crowns of the teeth can be inadvertently fractured due to physical trauma or because of complications during tooth extraction procedures by practitioners. If this occurs, the root(s) or root tip(s) usually remain in the jaw. Now the practitioner is faced with causing increased trauma to the patient in order to remove these tooth remnants.

Present art uses either rudimental and unsophisticated tools which cause trauma to soft and hard tissue or more sophisticated devices whose expense makes them prohibitive for a typical practitioner The rudimental tools are used to loosen the tooth or portion of the tooth, elevate it and then remove it with forceps. This procedure can cause significant damage to adjacent tissue. Often the practitioner must excavate some of the jaw bone to provide the necessary room for the pick, elevator and bulky forceps. In some cases, a substantial amount of force is required which exacerbates the already difficult situation. If the practitioner is working near a sinus cavity, there is a danger that the root tip can be inadvertently driven into it.

Others have proposed the use of a screw or screw-like device which is embedded in the tooth and then used for the extraction. However, these screw or screw-like devices have limited success due to the splitting nature of screws or breakage of the device itself due to the inherent weakness when it is made sufficiently small so it can be screwed into the nerve canal.

Even with skill and experience, this procedure can lead to a decrease in patient satisfaction; an increased in healing time due to jaw bone loss, blood vessel and nerve damage; loss of time for the practitioner & patient and re-scheduling issues, thereby reducing productivity of the practice.

### SUMMARY OF THE INVENTION

The disclosed present invention uses various extraction burs to complete the tooth or portion of tooth extraction in a matter of minutes; while minimizing soft and hard tissue damage. In one case, implementation begins when the practitioner uses a drill to make a hole in the tooth or portion of tooth. The drill provides a resultant hole that is sized correctly to accept the Extraction Bur.

The Extraction Bur is embedded in the hole and secured there using various means. Typically, the practitioner cuts the periodontal ligament and other soft tissue to help minimize the forces necessary for the extraction. Then the practitioner attaches a handle to the Extraction Bur and the Extraction Bur and tooth or portion of tooth is removed.

In an alternative case, no hole is required since the Extraction Bur is attached to the surface of the tooth or portion of tooth. Once attached, the practitioner completes the process as described in paragraph 007.

### BRIEF DESCRIPTION OF THE DRAWINGS

FIG. 1 Extraction Bur that uses a drill for dual purpose

FIG. 2 Extraction Bur that has an expansion collar

FIG. 3 Extraction Bur that has barbs

FIG. 4 Detail of barb

FIG. 5 Extraction Bur that has a series of discs

FIG. 6 Detail of discs

FIG. 7 Extraction Bur that can be attached to the tooth's surface

FIG. 8 Extraction Bur attached to the handle

FIG. 9 Handle with typical Extraction Bur embedded in tooth

### DETAILED DESCRIPTION OF THE PREFERRED EMBODIMENT OF THE INVENTION

In this detail, we use the word tooth to describe either a tooth or portion of tooth.

We have derived a number of Extraction Burs that can be used to remove a tooth. Fundamentally they can be divided into two groups. In case one, the Extraction Bur is embedded in a hole. In case two, the Extraction Bur is attached to the surface of the tooth.

Case one begins when a drill is locked in the practitioner's slow speed hand piece and used to create a hole in the tooth. Drills are sized to provide a hole that allows the Extraction Bur maximum engagement with the tooth.

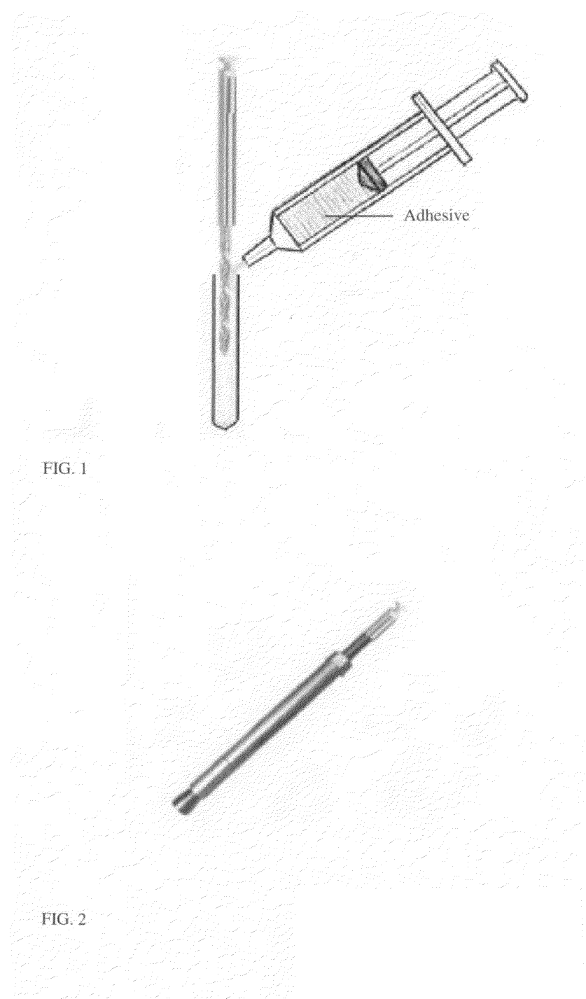

FIG. 1 illustrates and Extraction Bur which uses the drill as the Extractor. Once the hole is established, the drill can be removed from the slow speed hand piece and cleaned. Then using an adhesive to coat the drill, it is re-inserted in the hole. When the drill is bonded to the tooth, the practitioner attached the handle to the drill and uses it to luxate the tooth/remove it.

FIG. 2 illustrates an Extraction Bur that also uses the case one scenario. After the hole is drilled, the Extraction Bur is placed in the hole and a wrench is used by the practitioner to tighten the lead screw which, in turn, expands the expansion collar of the Extraction Bur.

Typically, the expansion collar is made from a soft metal which helps to ensure that the expansion ring “molds” to the interior of the hole thereby providing sufficient friction to lock the Extraction Bur in place. Again, the handle is attached to the Extraction Bur and used by the practitioner to remove the tooth.

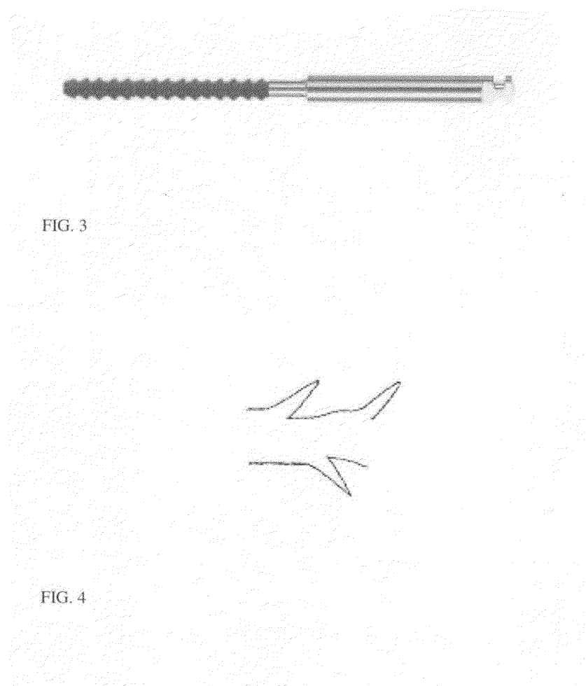

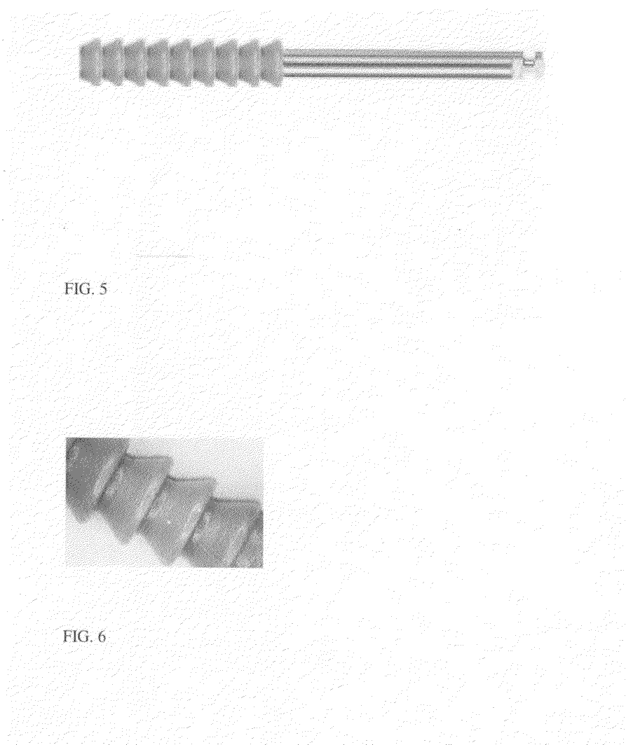

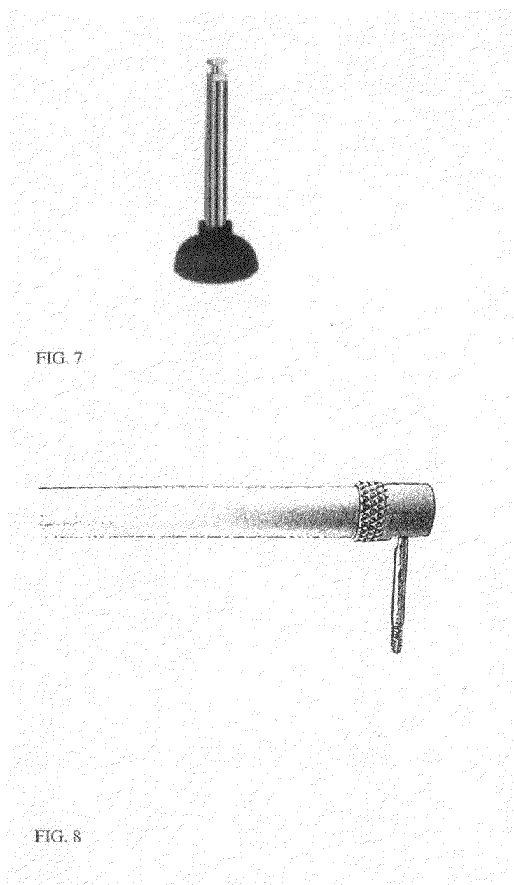

FIGS. 3 & 4 illustrates an Extraction Bur that is also placed in a drilled hole. The practitioner pushes this version into the hole after attaching the handle. When an upward force is exerted on the handle, the barbs of the Extraction Bur are forced into the wall of the hole. The engagement of the barbs to the wall prevents the Extraction Bur from slipping out of the hole as the practitioner luxates the tooth for removal.

FIGS. 5 & 6 illustrates yet another Extraction Bur that is placed in a drilled hole. This device is forced into the hole after attachment to the handle. This Extraction Burs uses a series of flexible discs that fold towards the shaft of the Extraction Bur as it is pushed into the hole. When force is applied to the Extraction Bur away from the hole, the edges of the discs grip the wall with sufficient friction to allow the practitioner to remove the tooth.

FIG. 7 illustrates an Extraction Bur that does not require a hole for attachment to the tooth. Instead the Extraction Bur has a cup shaped end which can be filled with an adhesive and attached to the tooth. The end of the Extraction Bur does not necessarily need to be cupped shape. The idea is to provide a larger surface area for the tooth to Extraction Bur interface where the adhesive resides.

FIG. 8 shows the handle attached to a typically detachable Extraction Bur.

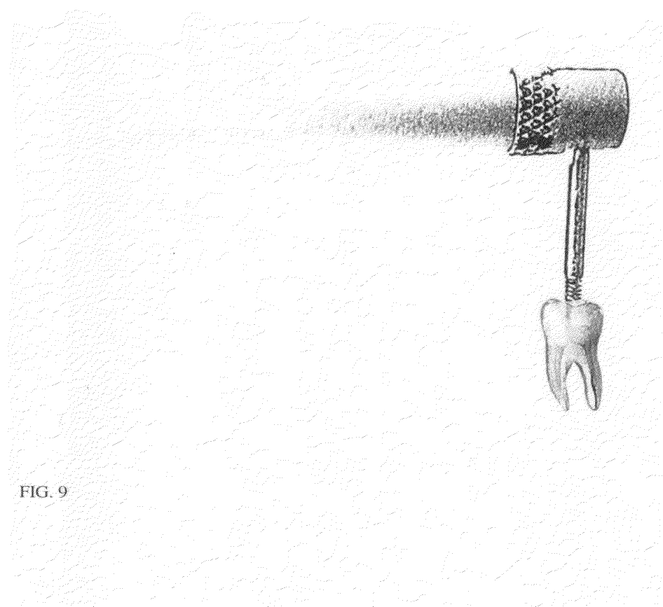

FIG. 9 shows the results of an extraction with the Extraction Bur embedded in the tooth and attached to the handle.

Because practitioners have adolescents, adults and animals as patients, all of the various Extraction Burs can be provided in different lengths and diameters to accommodate the variances in the teeth and jaws.

The handle allows a specific range of motion for the Extraction Bur when it's attached so the pulling action can be off-axis of the handle itself. This aspect of the design reduces the possibility that the practitioner does not apply too much torque to the shaft of the Extraction Bur causing breakage.

When the tooth has had previous dental work; e.g. a root canal procedure, the practitioner may determine that the Extraction Bur sized for the hole does not hold sufficiently during luxation and their attempt to extract the tooth. In this case, the practitioner can select a larger diameter Extraction Bur and repeat the process. They may find it necessary to repeat with an even larger Extraction Bur a third or more times.

The Extraction Burs presents a number of benefits to both the practitioner and the patient:
Reduces trauma to soft and hard tissues
Reduces healing time
Minimizes surgical procedures
Reduces risk of damage to sinus cavity
Eliminates/reduces excess bone removal
Reduces risk of damage to blood vessels
Increases patient satisfaction
Preserves ridge
Quickens implant placement
Reduces risk of damage to nerves
Improves productivity

That which is claimed:

1. Extraction Burs to extract a tooth or a portion of a tooth from a human or animal patient, said Extraction Burs comprising:
a) FIG. 1 Extraction Bur that uses a drill with one or more flutes and an adhesive to bind the dill in the pilot home. The adhesive can have various curing properties; including but not limited to UV, pressure, anaerobic, catalyzed.
b) FIG. 2 Extraction Bur that has an expansion collar made from a malleable material, a lead screw with a conical end or other method to expand the collar into the walls of the hole.
c) FIG. 2 The Extraction Bur claimed in b) that uses a cam shape shaft to expand the collar.
d) FIG. 3 Extraction Bur that has barbs as detailed in FIG. 4. The barbs are semi-flexible, that is, the outside diameter of the barbs is greater than the pilot hole. The barbs can be made of any material that is suitable to the necessary flexing and has sufficient strength to grip the wall of the hole. The barb count can vary from one to many.
e) FIG. 5/6 Extraction Bur that has a series of semi-flexible discs that lock into the wall of the pilot hole when the bur is attempted to be pulled out of the hole. The disc count can vary from one to many. The material can also vary from various plastics and metals.
f) FIG. 7 Extraction Bur that can be attached to the tooth's surface
g) FIG. 8 Extraction Bur attached to the handle to illustrate one option of an instrument that is used to provide leverage for the practitioner as they manipulate the tooth or portion of tooth.
h) FIG. 9 Handle with illustrating a typical Extraction Bur embedded in tooth after extraction.
